(19) United States
(12) Patent Application Publication
(10) Pub. No.: US 2010/0263217 A1
(43) Pub. Date: Oct. 21, 2010

(54) Food mincer with retractable blade cover

(76) Inventors: Anthony Baxter, Upper Montclair, NJ (US); Alberto Mantilla, Rego Park, NY (US); Marisol Rodriguez, New York, NY (US); Lucas Wade, Brooklyn, NY (US); Robert Nightingale, Brooklyn, NY (US); Jason Liang, Fresh Meadows, NY (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/799,008

(22) Filed: Apr. 15, 2010

Related U.S. Application Data
(60) Provisional application No. 61/169,329, filed on Apr. 15, 2009.

(51) Int. Cl. A47J 43/28; B26B 5/00; B26B 25/00; B26B 29/00

(52) U.S. Cl. 30/287; 30/304; 30/337; 30/307

(57) ABSTRACT

A food mincer assembly comprises a handle assembly, a retractable blade cover, and a plurality of blades. The handle assembly has a first side and a second side. The first side has a first through hole and the second side has a second through hole. The retractable blade cover has a cover portion, a lock, and a connecting arm. The connecting arm attaches the blade cover to the handle assembly. The lock secures the blade cover in a first position or a second position. The plurality of blades attach to the handle assembly. The first position of the retractable blade cover covers the plurality of blades. The second position of the retractable blade cover exposes the plurality of blades.

### RELATED APPLICATIONS

This application claims priority to U.S. Provisional Patent Application No. 61/169,329 filed on Apr. 15, 2009, and that application is incorporated herein in its entirety by this reference.

### TECHNICAL FIELD

The present invention relates to a food mincer, and more particularly, to a food mincer with a retractable blade cover removable blade assembly.

### BACKGROUND OF THE INVENTION

When preparing certain foods, it is sometimes necessary to utilize a food mincer to mince a food item. For instance, when preparing an onion for use in various recipes, it is often necessary to cut the onion into small pieces, a process sometimes referred to as mincing. Additionally, many herbs, nuts, and cooked meats are also minced prior to being used in a recipe. While it is possible to use a knife to mince a food product, it is often simpler to use a mincer to mince a food product. A mincer often includes a plurality of blades that are spaced apart to allow the food to be cut into small pieces by rolling the blades over the food. However, past mincers have also had inherent shortcomings. For example, some past mincers have left the blades exposed, increasing the likelihood of a user being inadvertently cut by the mincer. Other past mincers have had removable blade covers that allow the mincer to be stored without the blades exposed, reducing the risk of a user being cut by the mincer. However, these removable blade covers often are separated from the mincer, and thus, the user may be injured by the exposed blades. Further, as with any removable object, the removable blade cover may be lost or misplaced.

Thus, it would be useful to provide a mincer with an attached retractable blade cover that moves to an open position that allows the blades to contact food, and to a closed position that prevents the blades from being contacted. Further, it would be useful to provide a mincer that allows the blades to be removed for easy cleaning or replacement. Therefore, a need exists for a mincer with an attached retractable blade cover.

The present invention is provided to solve the problems discussed above and other problems, and to provide advantages and aspects not previously provided. A full discussion of the features and advantages of the present invention is deferred to the following detailed description, which proceeds with reference to the accompanying drawings.

SUMMARY OF THE INVENTION

According to one embodiment, a food mincer assembly comprises a handle assembly, a retractable blade cover, and a plurality of blades. The handle assembly has a first side and a second side. The first side has a first through hole and the second side has a second through hole. The retractable blade cover has a cover portion, a lock, and a connecting arm. The connecting arm attaches the blade cover to the handle assembly. The lock secures the blade cover in a first position or a second position. The plurality of blades attach to the handle assembly. The first position of the retractable blade cover covers the plurality of blades. The second position of the retractable blade cover exposes the plurality of blades.

According to another embodiment, a food mincer assembly comprises a handle assembly, a retractable blade cover, and a removable blade cartridge. The handle assembly has a first side and a second side. The first side has a first through hole and the second side has a second through hole. The first side has a first cutout region and the second side has a second cutout region. The retractable blade cover has a cover portion, a lock portion, and a connecting feature. The connecting feature attaches the blade cover to the handle assembly. The lock portion secures the blade cover in a first position or a second position. The removable blade cartridge has a plurality of blades. The removable blade cartridge is received by the first cutout region and the second cutout region of the handle assembly. The removable blade cartridge has a first blade mounting mechanism and a second blade mounting mechanism. The plurality of blades are disposed between the first blade mounting mechanism and the second blade mounting mechanism. The first position of the retractable blade cover covers the plurality of blades, and the second position of the retractable blade cover exposes the plurality of blades

According to a further embodiment, a food mincer assembly comprises a handle assembly, a retractable blade cover, and a removable blade cartridge. The handle assembly has a first side and a second side. The retractable blade cover has a cover portion, and a connecting feature. The connecting feature attaches the blade cover to the handle assembly. The retractable blade cover is positionable between a first position and a second position. The removable blade cartridge has a plurality of blades. The removable blade cartridge is received by the handle assembly. The first position of the retractable blade cover covers the plurality of blades, and the second position of the retractable blade cover exposes the plurality of blades.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a mincer with a retractable blade cover in a closed position according to one embodiment;

FIG. 2 is a back view of the mincer of FIG. 1;

FIG. 3 is a front view of the mincer of FIG. 1;

FIG. 4 is a side view of a first side of the mincer of FIG. 1;

FIG. 5 is a side view of a second side of the mincer of FIG, 1;

FIG. 6 is a bottom view of the mincer of FIG. 1;

FIG. 7 is a top view of the mincer of FIG. 1;

FIG. 8 is a perspective view of the mincer of FIG. 1 with the retractable blade cover in an open position;

FIG. 9 is a side view of the first side of the mincer of FIG. 1 with the retractable blade cover in an open position;

FIG. 10 is a bottom view of the mincer of FIG. 1 with the retractable blade cover in an open position;

FIG. 11 is a side view of a mincer with a retractable blade cover in an open position according another embodiment;

FIG. 12 is a top view of the mincer of FIG. 11

FIG. 13 is a side view of the mincer of FIG. 11 with the retractable blade cover in a closed position;

FIG. 14 is a side view of the mincer of FIG. 11 with the retractable blade cover in a first position while the blade cover is being removed;

FIG. 15 is a side view of the mincer of FIG. 11 with the retractable blade cover in a second position while the blade cover is being removed;

FIG. 16 is a detailed view of a portion of FIG. 15;

FIG. 17 is a side view of the mincer of FIG. 11 with the retractable blade cover completely removed;

FIG. 18 is a side view of the mincer of FIG. 11 with the retractable blade cover completely removed and the blade assembly removed;

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

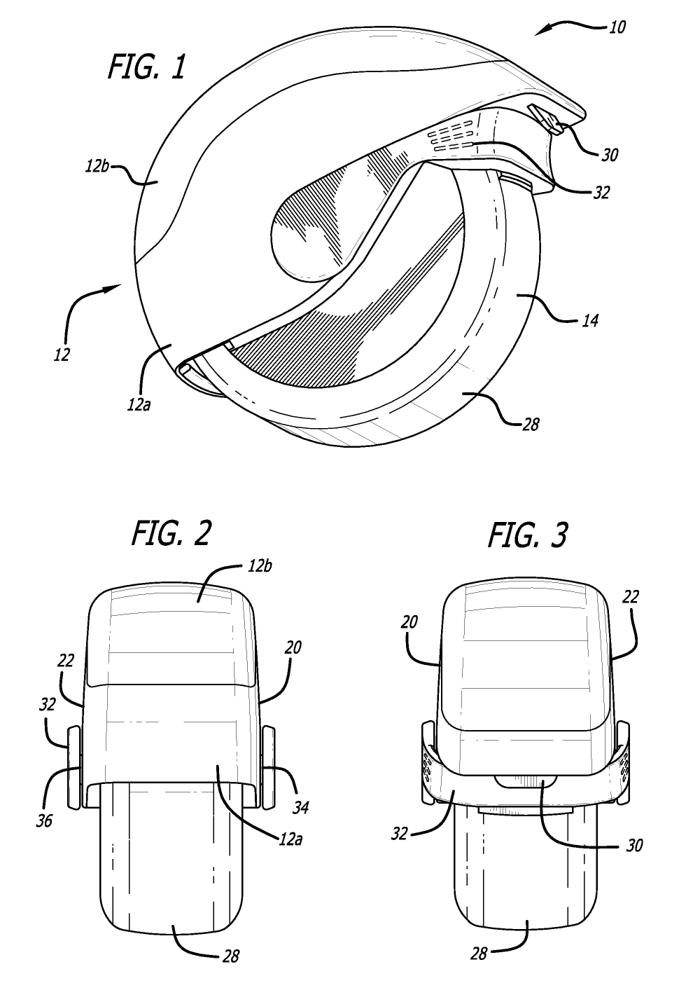

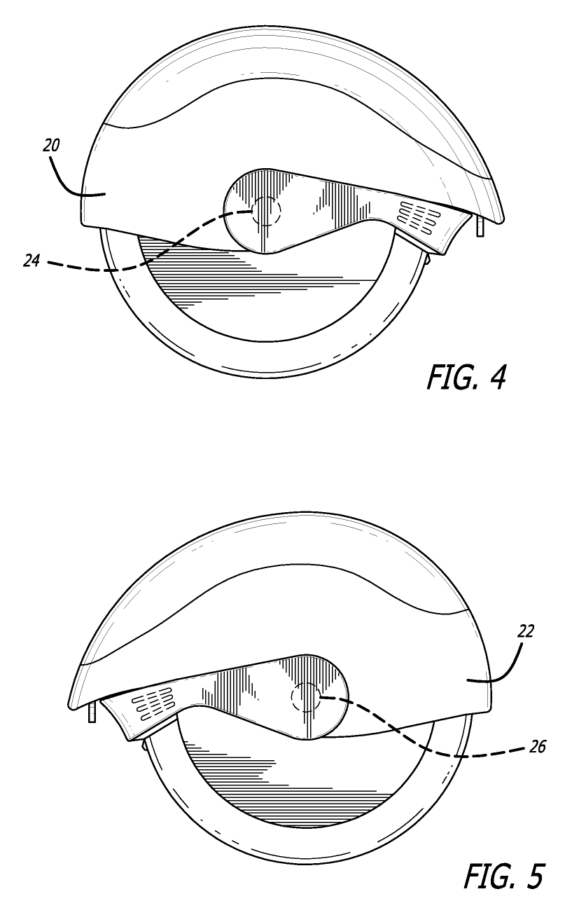

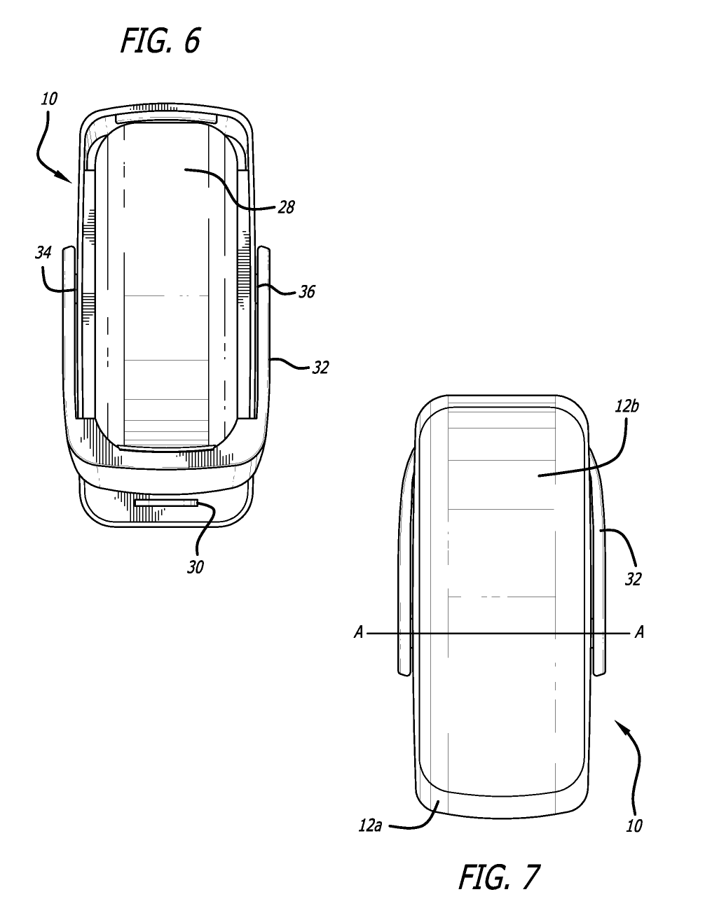

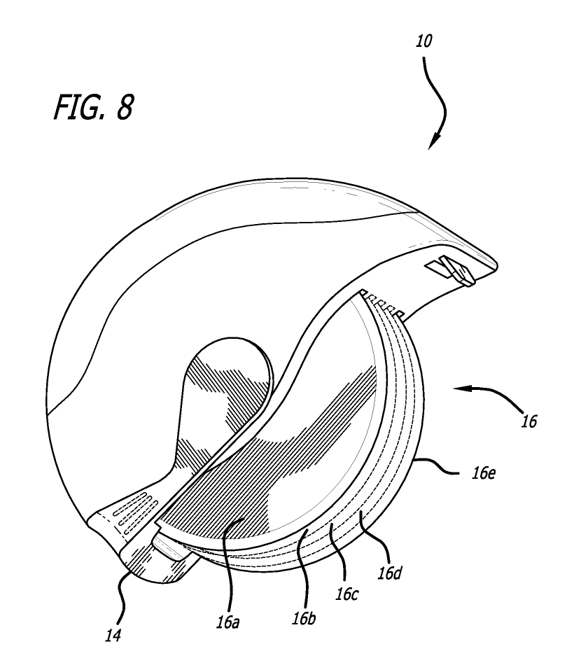

According to one embodiment of the present invention as shown in FIGS. 1-7, a mincer 10 is provided. As will be discussed below, according to one aspect of the invention, the mincer 10 comprises a handle assembly 12, a retractable blade cover blade cover 14, and a plurality of rotatable circular cutting blades 16 (see FIG. 8). The handle assembly 12 comprises a first body member 12a and a second body member 12b. The first body member 12a is adapted to allow a user to grasp a first side 20, and a second side 22 of the body member 12a while using the mincer 10. The second body member 12b attaches to the first body member 12a. The second body member 12b may comprise a slip resistant material that provides an enhanced grip, such as silicone, rubber, or other easily gripped material, to allow a user to more securely grasp the mincer 10. It is contemplated that the second body member 12b may be connected to the first body member 12a in a variety if manners, such as, a friction fit, an adhesive bond, overmold adhesion, mechanical fasteners, or other known fastening manners. The first side 20 has a first through hole 24 formed therein, while the second side 22 has a second through hole 26 formed therein. As will be explained in more detail below, the first and second hole allow the retractable blade cover 14 and the cutting blades 16 to mount to the handle assembly 12. It is also contemplated, according to alternative embodiments, that a thumb grip may be provided on the first side 20 and the second side 22 to further improve the users ability to grip the mincer 10.

The retractable blade cover 14 includes a cover portion 28, a lock portion 30, and connecting arm 32. The cover portion 28 is adapted to be positioned over the cutting blades 16 to prevent the blades 16 from being contacted. The lock portion 30 allows the blade cover 14 to be releasably locked in a position covering the blades 16, so that the blade cover may be retracted to an open position, as shown in FIG. 8, exposing the blades 16, and also releasably locking in the open position. The lock 30 interacts with the first body member 12a to secure the blade cover 14 in a closed position.

The connecting arm 32 has a first protrusion 34 and a second protrusion 36 that cooperate respectively with the first through hole 24 and the second through hole 26 of the first body member 12a. The protrusions 34, 36 connect the blade cover 14 to the handle assembly 12. The protrusions 34, 36 allow the blade cover 14 to rotate about a central axis A-A shown in FIG. 7.

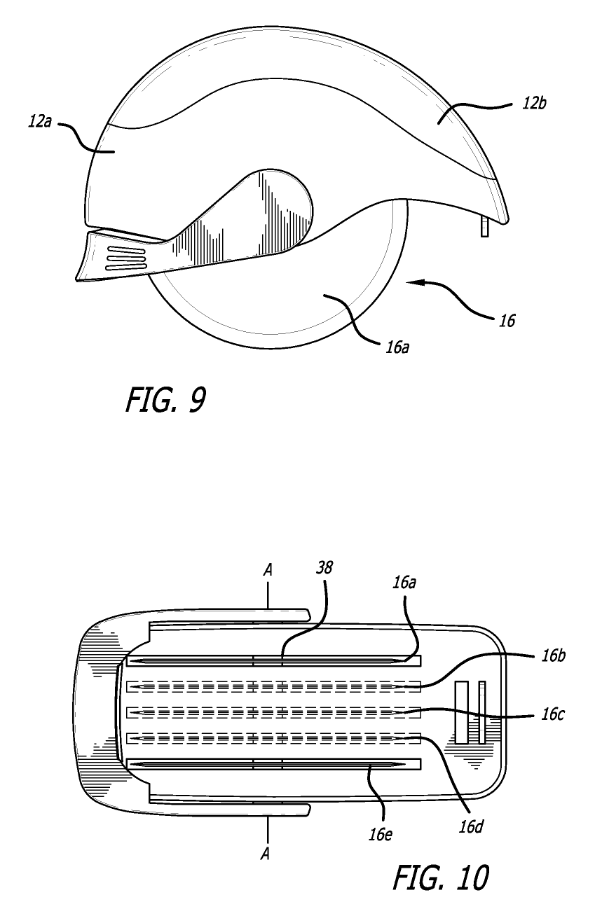

In order to expose the blades 16, the lock portion 30 is displaced to release the retractable blade cover 14. The connecting arm 32 rotates about axis A-A about one-hundred-eighty degrees (180°) positioning the blade cover 14 to a retracted position, as shown in FIG. 8. The cover portion 24 rotates into the handle assembly 12, exposing the blades 16. The blade cover 14 additionally locks in the open position, allowing a user to more easily mince a food without needing to attend to the blade cover 14. As shown in FIGS. 8-10 five blades 16a-16e are shown. The blades 16a-16e are generally spaced an equal distance apart, in order to mince food into similar size pieces. The blades 16a-16e are supported on an axle 38. The axle 38 aligns with the axis A-A of the blade cover 14. The axle 38 is supported by the first and second through holes 24, 26 of the first body member 12a. Thus, both the blades 16 and the blade cover 14 rotate about the axis A-A.

According to an alternate embodiment, it is contemplated that the plurality of blades 16 may be provided as a blade cartridge. In this way, the blades 16 would be replaced as a unit, such as if the blades became damaged, worn, or another type of blade was needed for a specific type of food. Further, it is contemplated that the blades 16a-16e may be individually replaced, allowing a user to replace, for example, blade 16c if it became damaged or worn. It is further contemplated that spacers may be positioned between each of the blades 16a-16e. The use of spacers allows the distance between the blades to vary, or if larger spacers are used, some blades may be removed, allowing a user to create larger food pieces with the mincer 10.

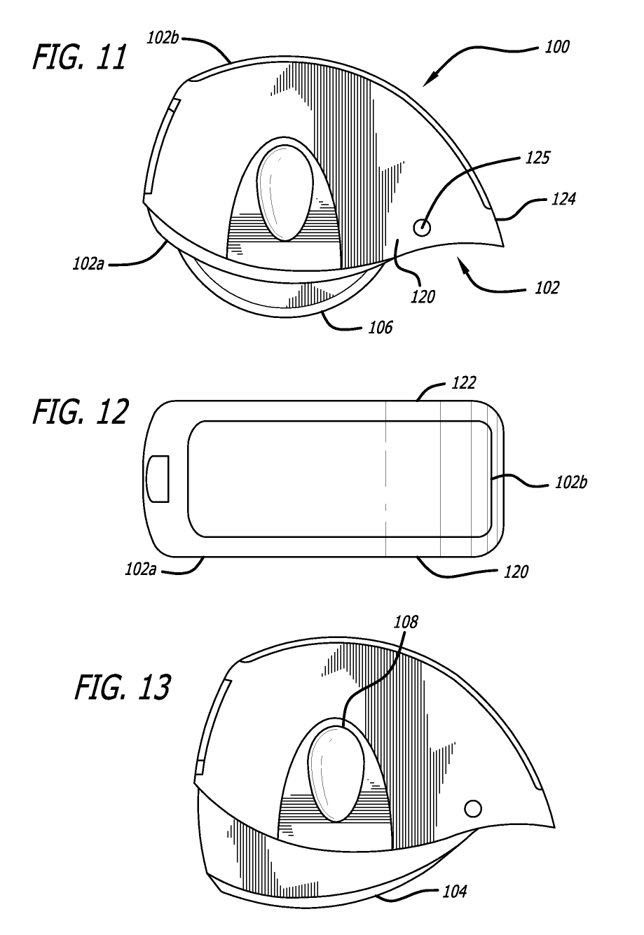

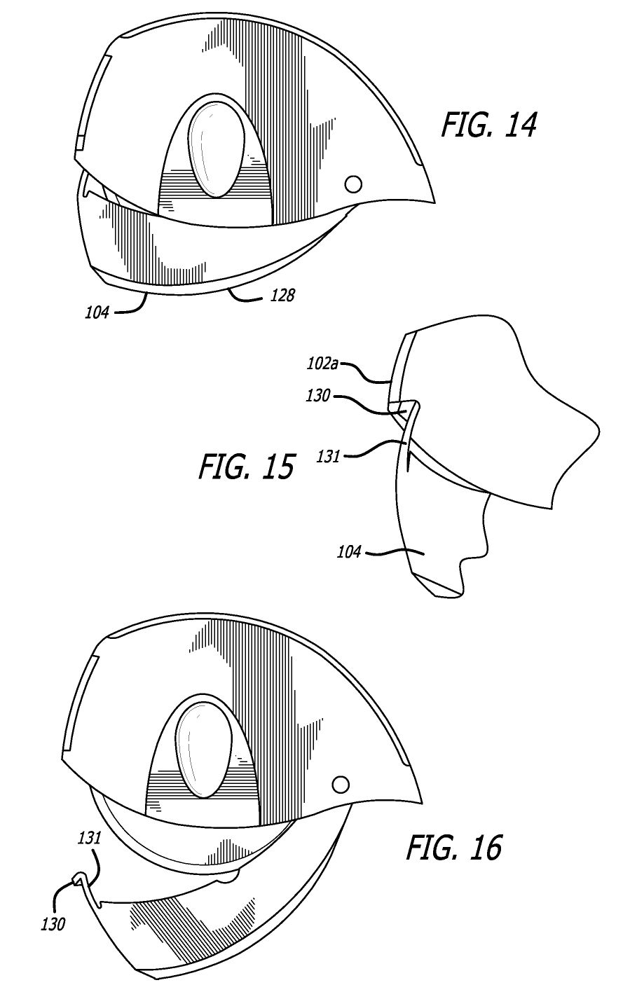

According to another embodiment, as shown in FIGS. 11-18, a mincer 100 is provided. As will be discussed below, according to one aspect of the invention, the mincer 100 comprises a handle assembly 102, a retractable blade cover blade cover 104, and a plurality of rotatable circular cutting blades 106 similar to blades 16 of FIG. 8. The handle assembly 102 comprises a first body member 102a and a second body member 102b. The first body member 102a is adapted to allow a user to grasp a first side 120, and a second side 122 of the body member 102a while using the mincer 100. The second body member 102b attaches to the first body member 102a. The second body member 102b may comprise a slip resistant material that provides an enhanced grip, such as silicone, rubber, or other easily gripped material, to allow a user to more securely grasp the mincer 100. It is contemplated that the second body member 102b may be connected to the first body member 102a in a variety if manners, such as, a friction fit, an adhesive bond, overmold adhesion, mechanical fasteners, or other known fastening manners. The first side 120 has a first through hole 124 formed therein, while the second side 122 has a second through hole, generally identical to the first through hole 124 formed therein. A pin, or axle, 125 is disposed between the first through hole 124 and the second through hole. The pin 125 serves as a pivot axis for the blade cover 104 to rotate relative to the housing assembly 102 between the blade covered position (FIG. 13) and the blade uncovered position (FIG. 11). As will be explained in more detail below, the first and second hole and the pin 125 allow the retractable blade cover 104 to pivotally mount to the handle assembly 102. It is also contemplated, that a thumb grip 108 may be provided on the first side 120 and the second side 122 to further improve the users ability to grip the mincer 100.

The retractable blade cover 104 includes a cover portion 128, a lock portion 130, and a connecting feature 132. The cover portion 128 is adapted to be positioned over the cutting blades 106 to prevent the blades 106 from being contacted. The lock portion 130 allows the blade cover 104 to be releasably locked in a position covering the blades 106, so that the blade cover may be retracted to an open position, as shown in FIG. 11, exposing the blades 106, and also releasably locking in the open position. The lock 130 interacts with the first body member 102a to secure the blade cover 104 in a closed position.

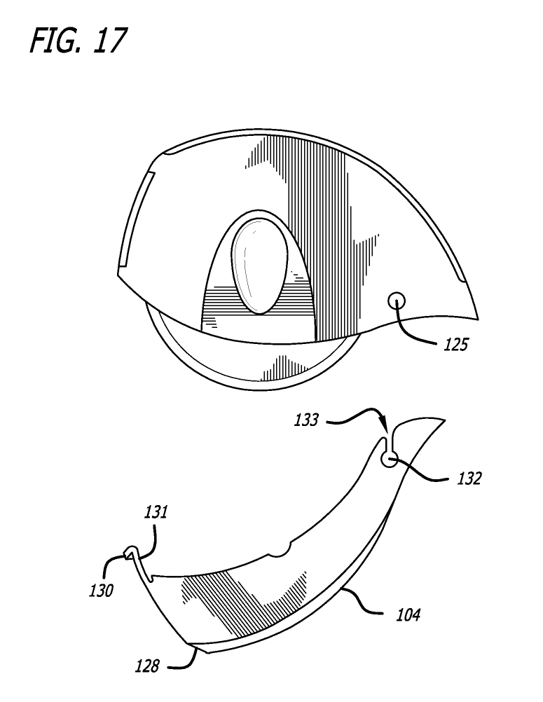

The lock 130 has a displaceable arm 131 that connects the lock 130 to the rest of the blade cover 104. The displaceable arm 131 allows the lock 130 to be removed from the handle assembly 102 so that the blade cover 104 may be completely removed from the handle assembly, as shown in FIG. 17. Once the lock 130 has been removed from the handle assembly 102, the blade cover 104 may pivot about the connecting feature 132 until a slot 133 of the connecting feature is in a generally vertical orientation and the blade cover 104 may be removed from the handle assembly 102. The pin 125 that resides in the first through hole 124 and the second through hole is sized to be reside in the connecting feature 132 when the blade cover 104 is connected to the handle assembly 102, and to pass through the slot 133 when the blade cover is being removed from the handle assembly 102.

In order to expose the blades 106, the lock portion 130 is displaced to release the retractable blade cover 104. The connecting feature 132 rotates about pin 125 about forty-five degrees (45°) positioning the blade cover 104 to a retracted position, as shown in FIG. 11. The cover portion 128 rotates into the handle assembly 102, exposing the blades 106. The blade cover 104 additionally locks in the open position, allowing a user to more easily mince a food without needing to attend to the blade cover 104.

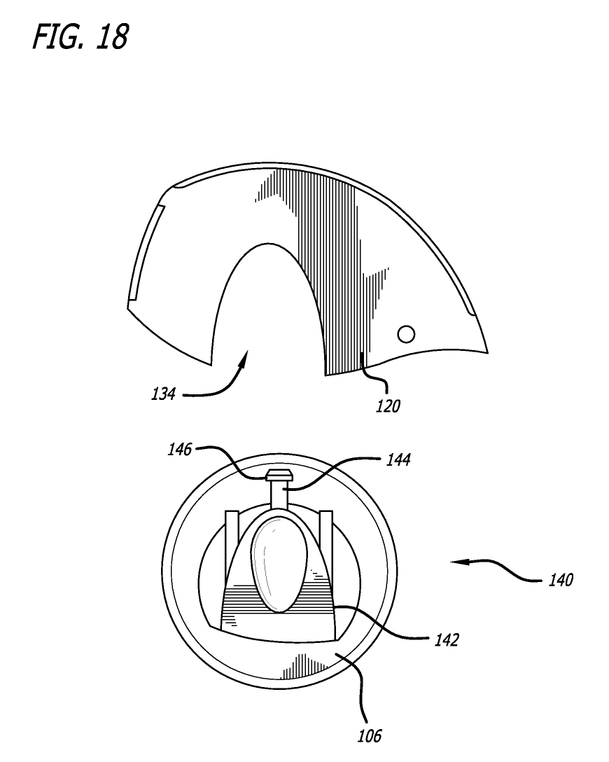

Tuning now to FIG. 18, the cutting blades 106 are shown as part of a blade cartridge 140. The blade cartridge 140 comprises the plurality of cutting blades 106 as well as a first blade mounting mechanism 142 and a second blade mounting mechanism that is similar to the first blade mounting mechanism 142 but located on the opposite side of the blade cartridge 140. The blade cartridge 140 is received into a cutout region 134 of the first body member 102a.

The first blade mounting mechanism 142 has a displaceable arm 144 with a generally laterally protruding ledge 146 at a distal end of the displaceable arm 144. The generally laterally protruding ledge 146 is adapted to be positioned within a slot formed in the first body member 102a when the removable blade cartridge is mounted to the handle assembly 102. The displaceable arm 144 may be displaced inward in a manner that the laterally protruding edge 146 exists the slot formed in the first body member 102a. When the second blade mounting mechanism is similarly activated, the blade cartridge 140 may be removed from the handle assembly 102. Additional operational details of the blade cartridge 140 may be found in U.S. patent application Ser. No. 12/191,082 entitled “Rotary Food Cutter With Removable Blade Assembly,” which is incorporated herein in its entirety by this reference.

While the specific embodiments have been illustrated and described, numerous modifications come to mind without significantly departing from the spirit of the invention, and the scope of protection is only limited by the scope of the accompanying Claims.

What is claimed is:

1. A food mincer assembly comprising;
a handle assembly having a first side and a second side, the first side having a first through hole and the second side having a second through hole; and
a retractable blade cover having a cover portion, a lock, and a connecting arm, the connecting arm attaching the blade cover to the handle assembly, the lock securing the blade cover in a first position or a second position; and
a plurality of blades, the plurality of blades attached to the handle assembly;
wherein the first position of the retractable blade cover covers the plurality of blades, and the second position of the retractable blade cover exposes the plurality of blades.

2. The food mincer assembly of claim 1, wherein the retractable blade cover and the plurality of blades attach to the handle assembly about a single axis.

3. The food mincer assembly of claim 1, wherein the handle assembly has a first body portion and a second body portion, the second body portion having a slip resistant material.

4. The food mincer assembly of claim 1, wherein the plurality of blades are mounted on a single axle,

5. The food mincer assembly of claim 1, wherein the plurality of blades form a removable blade cartridge.

6. The food mincer assembly of claim 1, wherein each of the plurality of blades is a rotatable circular blade disposed in parallel to the other of the plurality of blades.

7. A food mincer assembly comprising:
a handle assembly having a first side and a second side, the first side having a first through hole and the second side having a second through hole, the first side having a first cutout region and the second side having a second cutout region;
a retractable blade cover having a cover portion, a lock portion, and a connecting feature, the connecting feature attaching the blade cover to the handle assembly, the lock portion securing the blade cover in one of either a first position and a second position; and
a removable blade cartridge having a plurality of blades, the removable blade cartridge being received by the first cutout region and the second cutout region of the handle assembly, the removable blade cartridge having a first blade mounting mechanism and a second blade mounting mechanism, the plurality of blades being disposed between the first blade mounting mechanism and the second blade mounting mechanism, wherein when the retractable blade cover is in the first position the retractable blade cover covers the plurality of blades, and when the retractable blade cover is in the second position the retractable blade cover exposes the plurality of blades.

8. The food mincer assembly of claim 7 further comprising a pin disposed between the first through hole and the second through hole of the handle assembly, wherein the connecting feature of the retractable blade cover interacts with the pin to removably connect the retractable blade cover to the handle assembly

9. The food mincer assembly of claim 8, wherein the retractable blade cover pivots about the pin when moving between the first position to the second position.

10. The food mincer assembly of claim 7, wherein the handle assembly has a first body portion and a second body portion, the second body portion having a slip resistant material.

11. The food mincer assembly of claim 7, wherein the plurality of blades are mounted on a single axle.

12. The food mincer assembly of claim 7, wherein the majority of the retractable blade cover is positioned within the handle assembly in the second position.

13. The food mincer assembly of claim 7 wherein the lock portion has a displaceable arm, the displaceable arm being positionable to an unlocked position to allow removal of the retractable blade cover.

14. The food mincer assembly of claim 7 wherein the first blade mounting mechanism comprises a first displaceable arm having a generally laterally protruding ledge at a distal end of the arm.

15. The food mincer assembly of claim 14 wherein the second blade mounting mechanism comprises a second displaceable arm having a generally laterally protruding ledge at a distal end of the arm.

16. The food mincer assembly of claim 15, wherein the first blade mounting mechanism has a first blade bearing surface and the second blade mounting mechanism has a second blade mounting mechanism.

17. A food mincer assembly comprising:
a handle assembly having a first side and a second side;
a retractable blade cover having a cover portion, and a connecting feature, the connecting feature attaching the blade cover to the handle assembly, the retractable blade cover positionable between a first position and a second position; and
a removable blade cartridge having a plurality of blades, the removable blade cartridge being received by the handle assembly, wherein when the retractable blade cover is in the first position the retractable blade cover covers the plurality of blades, and when the retractable blade mechanism is in the second position the retractable blade cover exposes the plurality of blades.

18. The food mincer assembly of claim 18, wherein the handle assembly has a first body portion and a second body portion, the second body portion having a slip resistant material.

19. The food mincer assembly of claim 18, wherein the removable blade cartridge comprises a first blade mounting mechanism and a second blade mounting mechanism, the plurality of blades being disposed between the first blade mounting mechanism and the second blade mounting mechanism.
